(19) United States
(12) Patent Application Publication
(10) Pub. No.: US 2004/0123332 A1
(43) Pub. Date: Jun. 24, 2004

(54) Transmission systems

(76) Inventor: Barry A. Hanson, Canada (CA)

Correspondence Address: Diederiks & Whitelaw, # 301, 12471 Dillingham Square, Woodbridge, VA, 22192, US

(21) Appl. No.: 10/474,126

(22) PCT Filed: Apr. 4, 2002
(86) PCT No.: PCT/GB02/01611

(30) Foreign Application Priority Data
Apr. 4, 2001 (GB) 0108476.3

(51) Int. Cl. H04N 7/16; H04N 7/173

(52) U.S. Cl. 725/132; 725/114; 725/142; 725/140; 725/139

(57) ABSTRACT

A television broadcaster (which could be a satellite, cable or terrestrial, digital broadcaster) broadcasts from their broadcast head end via radio waves or a cable, as appropriate, linear digital television content to users' remote terminal digital television receivers or set top boxes. As well as broadcasting the linear television content, the broadcast head end also broadcasts as a continuous loop or carousel, software such as operating system software, application program interface software and television interactivity enabling software, that can be used by the set top boxes. This software is transmitted alongside and/or within the linear television signal, and uses the redundant space that is present in the digital television signal.

The present invention relates to the operation of transmission systems where one or more remote terminals of the system, such as television receivers, mobile phones, etc., receive transmissions from a main, central source. It is particularly applicable to systems in which the remote terminals are “thin clients” (in other words have relatively little memory and processing power of their own) of the main system and are coupled to the main system via a relatively high speed data transmission mechanism.

The present invention is particularly applicable to digital television systems, and will be described below with particular reference to television systems. However, as will be appreciated by those skilled in the art, the invention is equally applicable to “thin client” systems generally, such as appropriate mobile telephone systems, vehicular mounted computer systems, etc.

Broadcast television is shifting from analogue to digital systems. Digital signals use less bandwidth than analogue signals and so allow more efficient use of broadcast medium capacity, thereby enabling more channels to be delivered, and the possibility of delivering extra information with those channels. Digital systems are also faster and have greater capacity and are able to do more because of the capacity of digital information to communicate and integrate with other digital media. Thus digital television receivers (typically referred to as set top boxes (STBs)) can have additional functionality, for example to allow a television to be used more like a personal computer.

A further perceived advantage of digital television is the ability to provide enhanced interactive television services, that may, for example, combine television and Internet (world wide web) services.

However, there is a limit to the additional functionality that existing digital receivers and set top boxes can provide, because they operate in a “thin client” manner. (In other words they have relatively little resident memory, processing power and no hard disk drive.) This means that it is not, for example, readily possible to provide a full HTML/XML Web Browser to most existing digital television set top boxes.

These difficulties can be overcome in part by storing in the television set top box all of the desired, appropriate software, such as the necessary operating system software and web browsers. However, a drawback of this approach is that each set top box would then require the memory capacity to store the necessary software. Furthermore, such software would have to be stored in a non-volatile memory to allow for occasions when the set top box is switched off.

Current set top boxes typically have between 800 kilobytes and 64 megabytes of RAM with an industry average of 2.0 megabytes. This is insufficient for all the software that would be desirable to provide enhanced interactivity, and will not, for example, accommodate an HTML/XML Browser which can take up to 4.0 megabytes of RAM. The memory capacity of the receiver could be enhanced, e.g. by adding extra “non-volatile” memory such as flash RAM, or electronically erasable programmable read only memory (EEPROM), to the set top box, or by providing it with a hard disk drive. However, this would add significantly to the cost of the set top box. Furthermore, such an approach would require upgrading or replacement of existing set-top boxes.

The Applicants believe therefore that there remains a need for alternative ways of providing greater operating capabilities for thin client systems such as digital television set top boxes.

Thus, according to a first aspect of the present invention, there is provided a method of operating a digital transmission system comprising one or more remote terminals and a system infrastructure that makes transmissions to the remote terminals, the method comprising:

the system infrastructure transmitting to the remote terminals computer software for use by the remote terminals; and

the remote terminal or terminals receiving the software and storing it in their resident memory, whereby the remote terminals may use the transmitted software.

According to a second aspect of the present invention, there is provided a digital transmission system, comprising:

one or more remote terminals, each having a resident memory; and

a system infrastructure for making transmissions to the remote terminals of the system; wherein:

the system infrastructure comprises means for transmitting to the remote terminals computer software for use by the remote terminals; and

the or each remote terminal includes means for receiving the software and storing it in their resident memory, whereby the remote terminals may use the transmitted software.

In the present invention, software for use by remote terminals of the transmission system is transmitted to those terminals by the system infrastructure from which the remote terminals receive transmissions in their normal use. The remote terminals can then access and use that software as and when they need it. This allows software necessary for the operation of the remote terminals, such as interactivity enabling software (e.g web browsers), applications program interface (API) software, and operating system (OS) software, to be provided and available to the remote terminals, but without the need to prior load and store that software in the remote terminals.

Also, because the software is transmitted to the remote terminals in use, while the remote terminals need memory to store the software, that memory does not need to be of a non-volatile nature. Thus there is, for example, no need to include or add extra, expensive, (non-volatile) memory or a hard disk drive (which is also slow) to the remote terminals to allow the software to be used, and existing remote terminals can use the transmitted software without extensive upgrading or replacement.

Furthermore, because the software is transmitted and can therefore be placed in a remote terminal's memory as appropriate in use, more different software applications and, potentially, larger software applications, can be run on a remote terminal, without the need for additional memory in the remote terminals, by transmitting (and the remote terminal loading) different software applications at different times. Thus transmitting software to the remote terminals as in the present invention can reduce the constraints on the system due to the limited memory space that is resident in the individual remote terminals. Thus more, and more complex, software can be used in the “thin client” environment.

The Applicants believe that it is possible to transmit software in this way even in existing transmission systems, because they have recognised that in many digital transmission systems, such as digital TV broadcasts, there is typically a relatively large amount of unused transmission capacity (bandwidth) at any given time. This is because, for example with regard to television systems, digital data compression techniques such as MPEG-2 can compress an analogue television signal sufficiently that not all of the available bandwidth is needed to transmit the compressed signal all of the time. In practice the Applicants have found that between ten and twenty percent of the available digital television bandwidth goes unused. Similarly, in other transmission systems, such as mobile communications systems, the available transmission capacity may not be being used all of the time. The Applicants have recognised that this unused transmission capacity can be used to broadcast software to the remote terminals, for example in the case of digital television systems alongside the TV signal.

The present invention is applicable to “thin client” transmission systems generally, such as mobile communications systems (e.g. mobile phone systems or vehicular mounted navigation systems). However it is particularly applicable to digital television systems.

Thus, according to a third aspect of the present invention, there is provided a method of operating a digital television system comprising one or more remote digital television receivers, the method comprising:

broadcasting, as part of the television broadcast, software that can be used by the remote receiver or receivers;

the remote receiver or receivers receiving the broadcast software and storing it in their resident memory, whereby the remote receivers can access the software and use it as necessary for their operation.

According to a fourth aspect of the present invention there is provided a digital television system, comprising:

one or more remote digital television receivers each having a resident memory; and

means for broadcasting, as part of the television broadcast, software that can be used by the remote receiver or receivers; and wherein

the remote receiver or receivers include means for receiving the broadcast software and storing it in their resident memory, whereby the remote receivers can access the software and use it as necessary for their operation.

The software should be transmitted in a manner suitable to the transmission system in question. Thus, for example, the software can be transmitted on one or more transmission “channels” of the system. (As is known in the art, transmission systems generally use transmission “channels” for their transmission which may, for example, be separated on a frequency and/or time basis.) Thus in a television system the software is preferably transmitted on one or more of the existing television channels, and in a mobile communications system it is preferably transmitted on one or more of the existing radio or traffic channels of the system.

The remote terminals can then tune to the channel and in the process will receive the software, as they would for any other transmission. Where software is transmitted on more than one channel of the transmission system, each channel could carry the same or different software, as desired.

It will be appreciated that particularly where the software is transmitted on a given transmission channel, it would be possible and generally the case that plural remote terminals can and will receive the (same) software transmission simultaneously. Thus the present invention can and typically will transmit the software to plural remote terminals simultaneously via a single transmission.

The software transmission preferably takes place automatically, for example whenever the relevant transmission channel is transmitting. It preferably does not require, for example, any prompt or request for transmission from a remote terminal, or indeed a request for transmission made at the broadcast end. It also preferably does not require any response from a remote terminal (e.g. to indicate that it can receive software and/or that it has done so). It preferably also proceeds whether a given or all or any remote terminals are in use at the time or not.

A given software transmission could include only one piece of software, or could include different pieces of software that are sent, for example, in succession. Thus, for example, a transmission on a given channel could comprise transmission of a first software application, such as operating system software, followed by the transmission of a second software application such as web browser software, and so on.

While a given piece of software, e.g. individual program, or sequence of software pieces may be transmitted once only, preferably the or each piece of software or sequence of software is, preferably automatically, transmitted repeatedly in use, for example in a predetermined repeating order or pattern. Thus, for example, the software or software sequence on a given transmission channel (e.g. television channel) will automatically be repeatedly transmitted on that channel, The transmission could, for example, be repeated at predetermined, preferably regular, time intervals and/or upon the occurrence of one or more predetermined events. Preferably the software transmission is repeated at regular, short, time intervals, e.g. of a few seconds. In a particularly preferred such arrangement, the software is repeatedly and continuously transmitted, with a new transmission of the software starting immediately the preceding transmission has finished, without any substantial break therebetween. In such an arrangement, the software is effectively transmitted as a continuously repeating loop or carousel, and a given piece of software will become repeatedly available to the remote terminals over time. This helps to ensure that the software is available to any given remote terminal as quickly as reasonably possible after that terminal starts to receive the transmission. Preferably the software is broadcast, preferably continuously, whenever the corresponding transmission channel or transmission channel content is being broadcast. Preferably the software transmission takes place repeatedly over a relatively long time period, e.g. of an hour or more, or several hours or even days, preferably without a substantial break (e.g. of more than a few minutes or a few seconds) in the software transmission.

The software that is transmitted can effectively be selected as desired, although as will be appreciated by those skilled in the art, there may be a number of practical considerations that constrain what software can in practice be transmitted.

For example, while the present invention reduces the constraints on the system due to the size of the (typically) limited resident memory in the remote terminals (i.e. the “thin client” environment), it would still be necessary to ensure that any transmitted software is of a size that can be stored and used by the remote terminals. Thus, for example, in practice any software application (or part of an application—where the application has been re-constructed to run in distinct parts) transmitted by the system must be of a size that will fit suitably into the resident memory of the remote terminal(s).

It would also be desirable to ensure that any transmitted software can be accessed and used by a remote terminal in relatively short period of time, e.g. to allow a remote terminal to operate and use the software substantially instantaneously from a user's perspective. The time to transmit and load the software into the remote terminal will depend on the transmission capacity and the size of the software, so again this “time to load” constraint may limit in practice the size of software applications that can reasonably be transmitted. (Of course, these limitations can be reduced or overcome by appropriately increasing the volatile memory of the remote terminal and the transmission capacity, if desired.)

However, so long as any more practical considerations such as these are met, in general any desired software can be transmitted to the remote terminals.

The transmitted software should include software that it might be desired for the remote terminals to use. It therefore preferably includes one or more of, operating system software for the terminals, applications program interface software, and interactivity enabling software. The transmitted software could also comprise existing software packages such as word processing or spread sheet packages. For example, in a television system, software packages such as, e.g. Microsoft Excel, could effectively be delivered to a digital television set top box as a given, dedicated television channel, i.e. such that the software package is delivered to the set top box in the same way that a TV channel is delivered. This could, in effect, allow the set top box to act more as a personal computer, but without requiring, for example, a hard disk drive.

While a given piece of software, e.g. a given program, can be arranged as desired for its transmission, in a particularly preferred embodiment, each piece of software is transmitted in a linear fashion, from start to finish. In this case, the software is preferably divided into appropriately sized portions or packets for transmission (e.g. 56 k packets) which are then inserted into the transmission in the appropriate spaces in a linear order until the software transmission is completed (subject to any consideration for redundancies necessary to compensate for faults in the system).

The software should be arranged and loaded into the transmission transport stream in an appropriate manner to allow the remote terminals to receive and use it. While this can be done as desired, in a preferred embodiment the software is transmitted as fast as it can be, i.e. by placing it into all available space in the transmission as and when that space becomes available. This helps software to be transmitted to and used by the remote terminal in a rapid manner and therefore to provide relatively “seamless” operation from the perspective of a user of the remote terminal.

The software being transmitted is preferably marked in the transmission, so that the remote terminals can identify it. For example, the beginning and end of each piece of software (e.g. program) is preferably marked appropriately in the transmission to allow the remote terminals to identify the software. Where appropriate, preferably only the start of each separate software program is marked, with the remote terminals taking the indication of the start of a new piece of software as also signifying the end of the preceding piece of software.

The software should be broadcast in a format that is appropriate to the digital transmission protocol used by the transmission system. Thus, the software is preferably transmitted according to the transmission protocol used for other data transmission in the system in question, e.g. the transmission protocol used by the transmission system for its other “normal” transmissions. Thus, for example, in the case of a digital television system, the software is preferably broadcast using the same transmission protocol as is used for the normal television content broadcast, such as the MPEG-2 protocol.

Thus, according to a fifth aspect of the present invention, there is provided an apparatus for transmitting software to one or more remote receivers, comprising:

means for storing one or more software programs for broadcast to the remote receivers;

means for converting the stored software program or programs to a format suitable for transmission to the remote receivers; and

means for providing the converted software program or programs to a transport stream for transmission to the remote receiver or receivers.

According to a sixth aspect of the present invention, there is provided a method of transmitting software to one or more remote receivers, comprising:

converting the software program or programs to a format suitable for transmission to the remote receivers; and

providing the converted software program or programs to a transport stream for transmission to the remote receiver or receivers.

In a preferred embodiment, the transmission infrastructure determines the anticipated space available for the software transmission and, preferably, tailors the software transmission accordingly. This information can be useful for, for example, determining how long it may take a given piece of software to arrive at a remote terminal, and therefore whether it can acceptably be transmitted. Such a calculation could be based on, for example, the size of the software, and the space expected to be available in the transport stream in a given time interval. Such information and a calculation may be, for example, particularly useful where it is desired to transmit two (or more) software programs in succession, as it could indicate how long it would take to repeat one of the software programs in the transmission from the perspective of a remote terminal (and therefore whether such transmission was acceptable).

In the above arrangements, the space available in the transmission transport stream (e.g. channel) for the software can be calculated as desired. In the case of a satellite television broadcast, for example, the notional available transmission space for all data could be determined by calculating and calibrating the area under the transmission sine wave from the broadcast head-end to the remote set-top box (based on, e.g., the satellite's position and distance from the Earth—which information is typically available in such Systems), using, for example, appropriate Integral Calculus and Fourier's Theorem on Square Waves. The space needed for the normal television content could then be determined (this will vary depending on the complexity of the MPEG signal to be transmitted). The difference in these two values is then the space available in the transport stream for the software transmission.

It is believed that such a space calculation arrangement may be advantageous in its own right. Thus, according to a seventh aspect of the present invention, there is provided a method of operating a transmission system in which software is to be transmitted in a digital transmission stream, comprising

determining the overall transmission capacity available in the transmission stream, comprising

determining the transmission capacity required for current, non-software transmissions of the system; and

arranging the software for transmission in the transmission stream on the basis of the determined transmission capacities.

According to an eighth aspect of the present invention, there is provided a transmission system in which software is to be transmitted in a digital transmission stream, comprising

means for determining the overall transmission capacity available in the transmission stream;

means for determining the transmission capacity required for current, non-software transmissions of the system; and

means for arranging the software for transmission in the transmission stream on the basis of the determined transmission capacities.

The software alone may be transmitted (e.g. on the transmission channel), or it can be transmitted together with the information or data that the transmission system would in its normal use be transmitting to the remote terminals. Thus in the case of a television system, for example, the software is preferably broadcast alongside and/or within the linear television content being broadcast at that time, e.g. such that a given TV channel carries both the linear television content and the software stream. In such a TV system, preferably, where possible, there is also broadcast Internet content (using, for example, existing Internet Protocol (IP) streaming techniques) and/or other digital content (such as portal content, e-mail content and video telephony). Where IP content is to be broadcast, the IP content is preferably limited to a re-purposed front page to provide a visual bridge to an actual instructed dial-up to a URL or USL broadcast directly to the remote terminal, as this results in faster apparent access to the IP content.

In these arrangements, the transmitted software could be the same whatever the content of the other data being transmitted (e.g. TV signal), but preferably is dependent upon that other data, e.g. the TV signal content or TV channel being broadcast. Thus, for example, in a television system the arrangement is preferably such that changing TV channels will mean that the set top box will receive new software, e.g. interactive software, specifically relevant to the new TV channel (e.g. particular software unique to that TV channel broadcaster)

Where appropriate, the transmitted software should be synchronised and coordinated with the various digital data content streams that are being transmitted in addition to the software stream, such as the video content (e.g. MPEG) transport or broadcast stream, and the IP (e.g. web content and the Internet URL/USL Tag) data stream. The software must also be fitted into the existing transmission capacity, e.g. television channel, alongside the other data to be transmitted (if any). These processes can be carried out as desired and, for example, as discussed above, using calculations of the available space for the software in the existing transmission stream.

As discussed above, the transmitted software (and other digital content) should carry appropriate identifiers to allow the remote terminals to identify the different software and distinguish it from, e.g. the TV signal, to allow the terminals to process and use the software, etc., appropriately.

The software is transmitted by the system infrastructure to the remote terminals. Such infrastructure can comprise, for example, the satellite or cable broadcaster's head end in a digital television system, or the “fixed” network in a mobile communications system. The originating source of the software transmission in the system infrastructure can be any suitable component of or connected to that infrastructure. Thus the source that transmits the software could be, for example, a single such source, or a distributed plurality of sources that, for example, form the “fixed” infrastructure of the transmission system.

The present invention also extends to the necessary system infrastructure for making the software transmission. Thus according to a ninth aspect of the present invention, there is provided a method of operating a digital transmission system comprising one or more remote terminals and a system infrastructure that makes transmissions to the remote terminals, the method comprising:

the system infrastructure transmitting to the remote terminals computer software for use by the remote terminals.

According to a tenth aspect of the present invention, there is provided apparatus for making transmissions to remote terminals of a digital transmission system, comprising:

means for transmitting to the remote terminals computer software for use by the remote terminals.

According to an eleventh aspect of the present invention, there is provided a method of operating a digital television system comprising one or more set top boxes and a system infrastructure that makes transmissions to the set top boxes, the method comprising:

the system infrastructure transmitting to the set boxes computer software for use by the set top boxes.

According to a twelfth aspect of the present invention, there is provided apparatus for making transmissions to set top boxes of a digital television system, comprising:

means for transmitting to the set top boxes computer software for use by the set top boxes.

The software can be added to the signal to be transmitted where desired in the transmission system infrastructure. Thus, for example, in the case of a television system, the software can be added to the television signal to be broadcast at any appropriate point in the television broadcast system. It could, for example, be added at the central distribution point, or by the service provider (such as the cable platform or satellite platform operator), for the broadcast. This would be appropriate for, for example, software applications that are universal to all television channels. Alternatively or additionally, the software could be added by the TV channel content provider, e.g. TV broadcaster. This would be especially applicable to software that is unique to the individual broadcaster.

In a particularly preferred embodiment, the software to be transmitted is provided by a suitably located server. This server would be where all the software to be transmitted to the remote terminals, such as the operating systems, applications program interface, and applications, software, is resident and supplied from for transmission. In a digital television system, for example, this server would typically be located at the terrestrial, cable or satellite service provider's or broadcaster's head end of the system.

The transmission server preferably carries out the function of injecting the software resident on the server into the transmission (transport) stream in an appropriate manner, as discussed above. It preferably also, as discussed above, therefore calculates the space available in the transmission digital transport stream and divides the software up for delivery to the remote terminals in a linear manner.

The software transmission server preferably also coordinates and synchronises the different streams of digital content, such as digital broadcast content, portal content, E-mail content and video telephony content, if appropriate.

The remote terminals of the transmission system to which the software is transmitted can be any such terminals that are appropriate to a transmission system that delivers digital content to a “thin client” environment. Thus, for example, in the case of a digital television system the remote terminals will be set top boxes of the system, and in the case of mobile communications systems, the remote terminals can be mobile stations (e.g. phones) of the communications system. As will be appreciated by those skilled in the art, there will in practice normally be plural remote terminals in the transmission system.

The remote terminals will be “linked” to the transmission system infrastructure appropriately, by the transmission medium that the system uses. Thus in satellite television systems and mobile communications systems, the link would be via radio waves. In other cases the link could be hard-wired, e.g. optical fibres, such as in a cable television system.

The present invention also extends to remote terminals suitable for use in the systems of the present invention. Thus according to a thirteenth aspect of the present invention, there is provided a method of operating a remote terminal of a digital transmission system, comprising:

the remote terminal receiving software transmitted by the system infrastructure and storing it in its resident memory, whereby the remote terminal may use the transmitted software.

According to a fourteenth aspect of the present invention, there is provided a remote terminal of a digital transmission system, comprising:

a resident memory; and

means for receiving software transmitted by the system infrastructure and storing it in the resident memory, whereby the remote terminal may use the transmitted software.

According to a fifteenth aspect of the present invention, there is provided a method of operating a set top box of a digital television system, comprising:

the set top box receiving software transmitted by the television system infrastructure and storing it in its resident memory, whereby the set top box may use the transmitted software.

According to a sixteenth aspect of the present invention, there is provided a set top box of a digital television system, comprising:

a resident memory; and

means for receiving software transmitted by the television system infrastructure and storing it in the resident memory, whereby the set top box may use the transmitted software.

The remote terminals receive the transmitted software and load it into their resident memory. They can do this in any suitable Tanner and how this is carried out will depend, inter alia, on how exactly the software is transmitted. Preferably, the remote terminals identify a software transmission that they wish to use (e.g. from the software-indicating “markers” included in the transmission discussed above) and then read and reassemble the transmitted software, compile it if necessary, and store it in their local, resident memory, such that it is then available for use by the remote terminal. The BIOS (Basic Input Output System) of the remote terminal is preferably arranged and/or modified to provide and carry out these functions (such as reading, compiling and loading the software), as necessary.

The remote terminals store the transmitted software in their resident memory. However, as discussed above, that memory does not need to be non-volatile, as the software can always be retrieved again from the transmission if it is lost from the remote terminal's memory (e.g. because the remote terminal is switched off). Thus the remote terminals can be re-designed with larger amounts of less expensive memory, such as D/RAM, rather than needing a hard disk drive or other non-volatile storage devices such as EEPROM.

Furthermore, particularly where the software transmission is made repeatedly, the remote terminals do not need the memory capacity to store plural different software programs simultaneously, rather they can take the software that they currently need from the transmission and then replace that software in their memory with other transmitted software as and when their needs change. The original software can be reloaded if necessary when it is repeated in the transmission.

Indeed, in a particularly preferred embodiment, the or each remote terminal is arranged, where two or more separate pieces of software are being transmitted, to automatically switch or modulate between the different software and replace one with the other in its local resident memory as the remote terminal's software needs change. Thus, for example, the remote terminal in a digital television system could switch between storing in its resident memory, and using, a transmitted web browser, and other software, depending on the needs of the user. Such swapping of software in the terminal's resident memory preferably takes place at a predetermined speed. Where such changes in software use could be perceived by a user, they are preferably carried out at such a speed as to mask any discontinuities in operation from a user's perspective (e.g. so as to ensure that any screen display changes take place at speeds above 25 Hz, i.e. the flicker perception frequency of the human eye) The terminal's BIOS can be appropriately arranged to provide such a “swapping” or “modulation” function.

In a preferred embodiment, the remote terminals automatically erase whatever transmitted software is stored in their resident memory when they seek a new transmission, e.g. change transmission channels. The memory can also and usually will be cleared when the terminal is powered off and/or the terminal can be designed to emulate the “switch off” function for all or part of what is resident in volatile memory when the user of the remote device (e.g. set top box) changes channels. The terminals' BIOS can again be arranged to cause these functions to be carried out, if desired.

The remote terminals can be arranged to access and use the transmitted software as desired. Thus the remote terminals are preferably configured to look for and access the transmitted software as and when needed, for example in response to particular, predetermined events. These could be, for example, when the terminal is first powered on (this may be appropriate where the transmitted software is, for example, operating system software) and/or in response to particular user inputs (such as, e.g., a request for internet access, in response to which the terminal could search for transmitted web browser software). The transmission itself could also trigger the remote terminals to load the software, e.g. by including appropriate instructions and/or markers in the transmission.

The remote terminals are preferably arranged to at least seek software in the signal transmissions that they are receiving when they, for example, cannot find software code that they need in their local resident memory. (This could, for example, be similar to the original disk operating system, in that there are software instructions external to the central processing unit (CPU) of the receiver (which are transmitted in the broadcast signal), which the CPU is controlled to refer to as and when they are needed.)

Thus according to a seventeenth aspect of the present invention, there is provided a receiver of a digital transmission system, comprising:

means for determining whether a piece of software desired for operation by the receiver is stored by the receiver; and

means for, when it is determined that the piece of software is not stored by the receiver, seeking that software from a signal transmitted to the receiver by the digital transmission system.

According to an eighteenth aspect of the present invention, there is provided a method of operating a receiver of a digital transmission system, comprising:

the receiver determining whether a piece of software desired for operation by the receiver is stored by the receiver; and

the receiver, when it is determined that the piece of software is not stored by the receiver, seeking that software from a signal transmitted to the receiver by the digital transmission system.

The remote terminals preferably also include means for unbundling the digital data stream to provide the TV, audio, software, etc. broadcast, to the appropriate processors in the remote terminal.

It would be possible to appropriately modify existing transmission system remote terminals (e.g. digital television set top boxes) to look for and use the transmitted software in accordance with the present invention. As discussed above, it may only be necessary to modify the BIOS of the remote terminal to allow it to operate in accordance with the present invention—as it can use its existing memory.

Alternatively or additionally, a new design of terminal unit which is specially designed to seek its software from a transmitted signal could be used. Such a design may only need appropriate BIOS and memory facilities (and in particular may only need an extensive volatile, e.g. DRAM, memory), and need only include the Basic Input Output System (BIOS) and boot-up software in the ROM memory, as the remaining software necessary for operation of the terminal would be obtained from the software transmission. Indeed, it is a particularly significant advantage of the present invention that it facilitates the use of a new design of remote terminal (e.g. set top box) that can be based on inexpensive, low cost, volatile memory such as DRAM and thereby permits the creation of low-cost, “universal”, remote terminals (set top boxes). The present invention extends to such remote terminals and set top boxes.

In a particularly preferred embodiments a return path or “back channel” is provided for communication from the remote terminals to the transmission system infrastructure, e.g. TV broadcast provider, e.g. to access the broadcaster's Internet portal. This could use, for example, a phone line and modem, a personal satellite transmitter, a digital subscriber line (DSL), or a “cable modem” on a cable network, etc., as is known in the art.

With regard to television systems in particular, where interactivity enabling software is transmitted, that interactivity enabling software preferably allows different streams of digital information to be shown simultaneously, and, preferably manipulated, by the viewer, on a television screen, so as to, for example, allow the viewer to watch a linear TV broadcast and surf the Internet at the same time and on the same screen. Preferably E-mail functionality (whether to limited recipients or not) is also provided.

The methods in accordance with the present invention may be implemented at least partially using software e.g. computer programs. It will thus be seen that when viewed from further aspects the present invention provides computer software specifically adapted to carry out the methods hereinabove described when installed on data processing means, and a computer program element comprising computer software code portions for performing the methods hereinabove described when the program element is run on data processing means. The invention also extends to a computer software carrier comprising such software which when used to operate a transmission system and/or remote terminals of a transmission system comprising digital data processing means causes in conjunction with said digital processing means said system and/or terminals to carry out the steps of the method of the present invention. Such a computer software carrier could be a physical storage medium such as a ROM chip, CD ROM or disk, or could be a signal such as an electronic signal over wires, an optical signal or a radio signal such as to a satellite or the like.

It will further be appreciated that not all steps of the method of the invention need be carried out by computer software and thus from a further broad aspect the present invention provides computer software and such software installed on a computer software carrier for carrying out at least one of the steps of the methods set out hereinabove.

A number of preferred embodiments of the present intention will now be described by way of example only, and with reference to the accompanying drawings, in which:

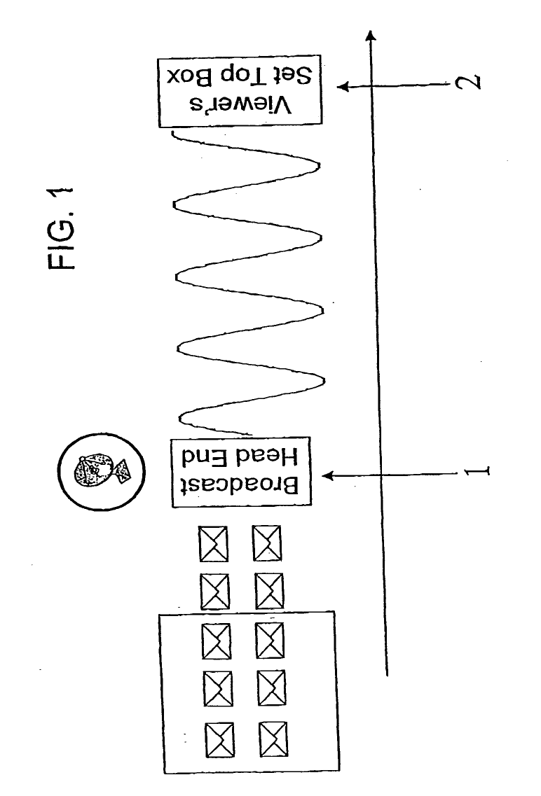

FIG. 1 shows schematically the transmission of software to a digital television receiver (set top box);

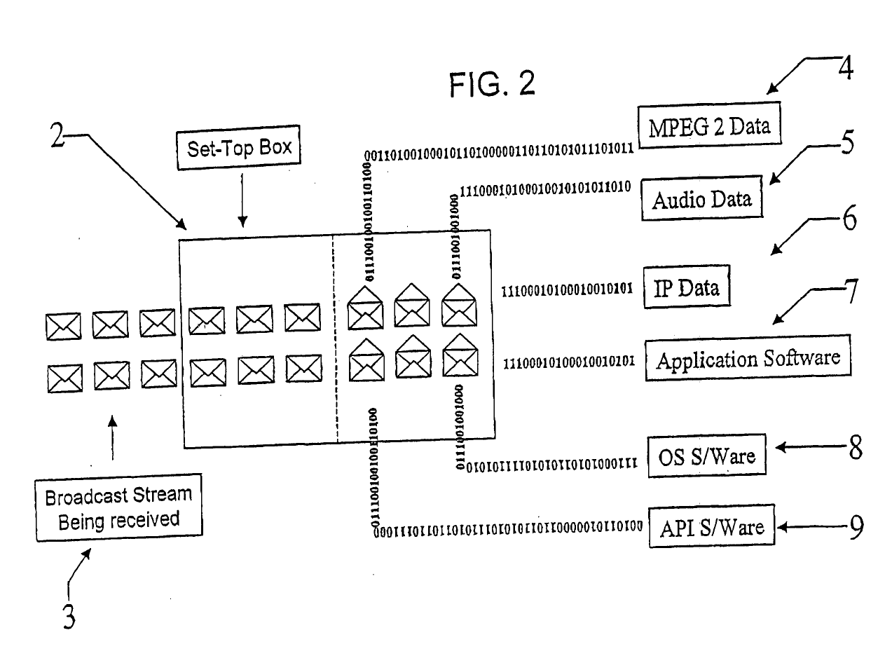

FIG. 2 shows schematically the receiver (set top box) processing the broadcast television signal;

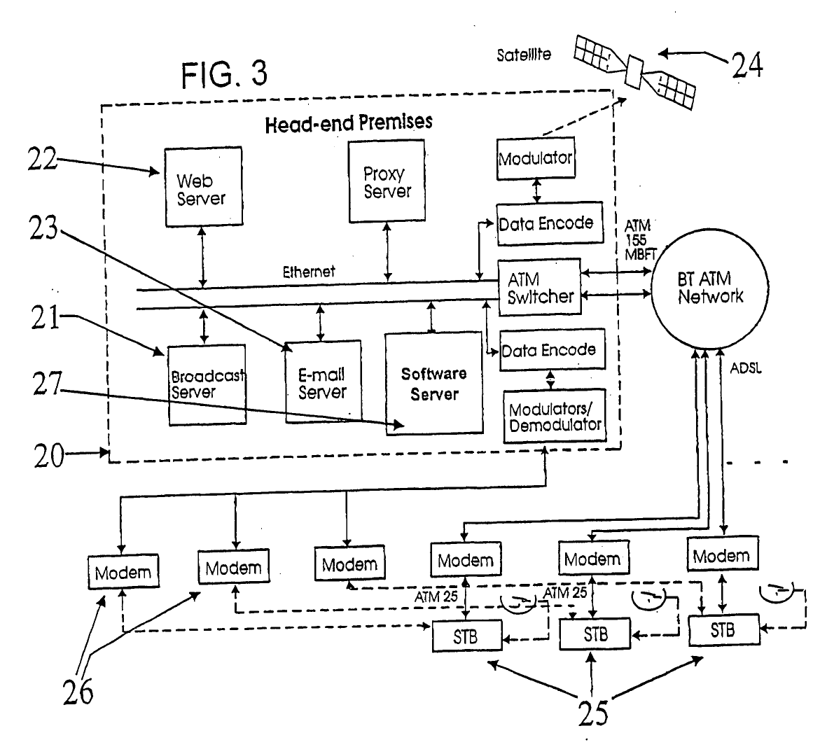

FIG. 3 shows schematically a television system architecture which uses the present invention; and

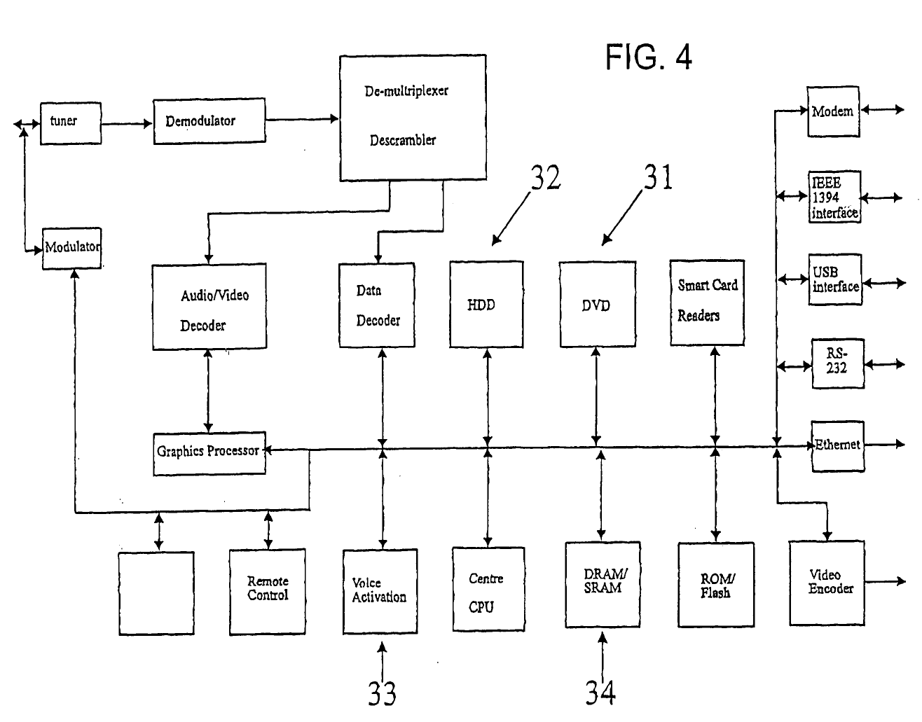

FIG. 4 shows schematically a digital television receiver (set top box) suitable for use with the present invention

FIG. 1 shows schematically the operation of the present invention in the context of a television system. The television broadcaster (which could be a satellite, cable or terrestrial, digital broadcaster) broadcasts from their broadcast head end 1 via radio waves or a cable, as appropriate, the linear digital television content to users' remote terminal digital television receivers or set top boxes 2. In accordance with the present invention, as well as broadcasting the linear television content, the broadcast head end 1 also broadcasts as a continuous loop or carousel, software that can be used by the set top boxes 2.

At the broadcast head end 1, control and process software appropriately encodes and processes for transmission, software that the set top boxes 2 will use, such as operating system software, application program interface software and television interactivity enabling software. This software is transmitted alongside and/or within the linear television signal, and uses the redundant space that is present in the digital television signal.

To transmit the software, a suitable processor at the broadcast head end firstly and continuously recalculates and recalibrates the area available under the transmission nine wave from the transmission head end of the system to the remote terminals of the system. This calculation can be based on, for example, the position of the satellite and its distance from the Earth. Such information is typically already available in satellite transmission systems from, for example, satellite control systems This calculation provides an indication of the overall transmission space available at any given time to the system.

The complexity of the television (MPEG) signal to be transmitted is also continuously derived. This value together with the overall transmission capacity then yields the net volume of space available in the transmission transport stream for the software transmission. The system can then tailor its software transmission accordingly.

To transmit the software, it is divided up in a linear fashion into appropriate data packets, such as 56 K data packets, which are then loaded into the empty space (i.e. typically null packets) in the television transmission. In this way, the software is transmitted to the remote terminals (set top boxes) of the television system. In other words, the software is re-configured and dis-assembled so that it can be sent as part of the MPEG-2 transport stream without disrupting the video, audio and textual content of the “normal” television signal.

The software transmission is repeated continuously, such that the software being transmitted repeats in the transmission continuously over time. Each individual version of the software is marked at its beginning and end by an appropriate marker to allow the remote terminals to determine when a relevant piece of software begins and ends in the transmission.

FIG. 2 shows schematically the operation of the set top box 2 upon receipt of the broadcast data stream. The set top box 2 receives the broadcast stream 3, identifies the different data types in the broadcast stream, unbundles the data, and sends it to appropriate processors, such as an MPEG-2 data processor 4, audio data processor 5, Internet protocol data processor 6, application software processor 7, operating system processor 8, and application program interface software processor 9, in the set top box. The set top box uses the transmitted data and software as appropriate and provides, for example, the video content to the television for display.

The set top box recognises and then receives the relevant transmitted software and loads the transmitted software into its local, resident memory (which as discussed above can be of a low-cost, volatile type) These functions are provided by expanding the BIOS (Basic Input Output System) of the set top box to include functions that effectively read the software from the transmission, reassemble the software (by, e.g., unbundling the transmitted software data packets and rebundling them as needed), compile the software, and load it into the set top box's memory, so that it is then available for use by the set top box. These BIOS functions are triggered by the markers indicating the presence of the software in the transmitted data stream.

The BIOS software in the set top box also acts as the internal interface between the set-top box applications (graphical) interface and the transmitted software that is (continuously) available in the television (MPEG-2) transport stream.

The set top box is preferably further arranged such that it erases its resident memory when it is switched off and/or when it changes television channels. This clears the memory for the loading of new software when the set top box is next switched on or tuned to the new channel. Again, the set top boxes BIOS is preferably modified to carry out these functions. The set top boxes are preferably configured to download the microkernal of the remote software server when their power is switched on.

In a preferred arrangement where software transmission comprises two or more different software applications, the set top box is arranged such that it will swap the software application stored in its memory between the software applications being transmitted as appropriate, for example in response to a particular user input. Thus the set top box could, for example, swap back and forth between storing an internet browser and operating system software. This switching of the software stored in the set top box's local memory preferably takes place at such a speed for the change to be imperceptible to a user. Thus where changes in screen displays will occur, the switch preferably takes place at speeds greater than 25 Hz.

FIG. 3 shows schematically a satellite television system that can operate in accordance with the present invention. The satellite broadcaster's head-end premises 20 include a number of servers, such as a broadcast server 21 which supplies the linear TV content, a web server 22 which provides Internet content, and an e-mail server 23, all of which provide data which is encoded and then appropriately broadcast by a satellite 24 to a plurality of remote set top boxes 25. All of these servers are coordinated and synchronised in accordance with the software that the remote terminals select from the broadcast stream. A return path is provided from the set top boxes to the satellite broadcast's head-end premises 20. In the present embodiment this is provided by means of modem links 26 over phone lines, although any suitable return path can be used.

In accordance with the present invention, as well as the broadcast, web and e-mail servers, the satellite broadcast's head-end premises includes a software server 27 which makes software available for broadcast to the set top boxes 25. The software server 27 stores, inter alia, direct real time operating system software for the set top boxes, and adds that operating system software, together with applications program interface software and interactivity enabling software to the digital signal that is transmitted to the set top boxes 25 on a continuous loop in real time, in the manner discussed is above. The set top boxes use the software to execute their different tasks. The software server 27 thus effectively acts as a “virtual” hard drive for the set top boxes.

FIG. 4 shows schematically a set top box suitable for use in a television system in accordance with the present invention. It will operate and have functions as discussed above. In particular its BIOS will be configured to operate as above, and it has and uses low cost DRAM memory 34 for storing the transmitted software.

The set top box shown in FIG. 4 includes a DVD system 31, HDD record and replay system 32 and a voice activation module 33, although those features are optional.

It can be seen from the above that the present invention, in its preferred embodiments at least, provides new server software in the form of an additional server that enables the broadcast directly to remote terminals of a transmission system of applications software, such as interactivity enabling software, applications program interface (API) software and the remote terminals' operating system software. This software is delivered on a closed loop transmission like a carousel, making whatever software has been added to the transmission signal available to the remote terminals as and when needed.

Thus the present invention allows, for example, a set of software instructions to be continuously delivered to a remote terminal that is connected to a central, head-end server via a high speed transmission mechanism such as the MPEG-2 transport stream. In the use of a digital television system, for example, it can allow all set top boxes tuned to a particular television channel to receive software transmitted from a central server located at the television broadcaster's head-end.

The software transmitting hardware and software is effectively simulates a hard drive in the remote terminals, i.e. provides a “virtual” hard drive for them.

The remote terminals can execute different tasks because the software transmission makes, for example, the applications program interface, operating system and interactivity enabling software available to the remote terminals on a carousel in real time.

By transmitting the software and thereby substantially reducing or eliminating memory constraints, the applications program interface, operating system and other, e.g. interactivity enabling, software can be made larger and more complex, thereby permitting enhancement of these applications.

The present invention can therefore provide in a television environment, for example, an enhanced interactive viewing experience at the upper end of the market, that can, for example, be customised for particular TV channels. At the lower end of the market it facilitates a digital television system (whether terrestrial, satellite or cable) that can use low cost, DRM-based, set top boxes. It can also allow significant Internet access via a television receiver and allow a TV set to function more like a personal computer via a relatively low cost set top box, and allow easy distribution of software to consumers.

The present invention will work with existing transmission system remote terminals, but also facilitates a lower cost, “universal” remote terminal or receiver (e.g. set top box) that does not need expensive memory and can, for example, rely on DRAM and Cache memory rather than flash RAM.

It also allows a common operating system to be used by any remote terminal regardless of its existing chip set and operating system.

The present invention has applicability to transmission systems generally, as it potentially allows any remote terminal to act as a thin client of a central transmitter. It is, as discussed above, particularly applicable to digital television systems and also to mobile communications systems. In the case of communications systems, for example, the invention could allow appropriate software packages to be delivered to plural remote users remotely. This may be particularly useful in emergency services and/or military applications.

1. A method of operating a digital transmission system comprising one or more remote terminals and a system infrastructure that makes transmissions to the remote terminals, the method comprising:
the system infrastructure transmitting to the remote terminals computer software for use by the remote terminals; and
the remote terminal or terminals receiving the software and storing it in their resident memory, whereby the remote terminals may use the transmitted software.

2. The method of claim 1, wherein the digital transmission system is a digital television system.

3. A method of operating a digital television system comprising one or more remote digital television receivers, the method comprising:
broadcasting, as part of the television broadcast, software that can be used by the remote receiver or receivers;
the remote receiver or receivers receiving the broadcast software and storing it in their resident memory, whereby the remote receivers can access the software and use it as necessary for their operation.

4. The method of claim 2 or 3, wherein the software is transmitted on one or more of the existing television channels of the system.

5. The method of any one of claims 1 to 4, comprising transmitting the software to plural remote terminals simultaneously via a single transmission.

6. The method of any one of claims 1 to 5, comprising automatically transmitting the or each piece of software or sequence of software repeatedly in use.

7. The method of any one of claims 1 to 6, comprising transmitting the software in a continuously repeating loop, such that a given piece of software will become repeatedly available to the remote terminals over time.

8. The method of any one of the preceding claims, wherein the transmitted software includes one or more of: operating system software for the terminals, applications program interface software, interactivity enabling software, and software packages such as word processing or spread sheet packages.

9. The method of any one of the preceding claims, comprising transmitting each piece of software in a linear fashion, from start to finish.

10. The method of any one of the preceding claims, comprising marking the software being transmitted in the transmission, so that the remote terminals can identify it.

11. The method of any one of the preceding claims, comprising transmitting the software according to the transmission protocol used for other data transmission in the digital transmission system.

12. The method of claim 11, wherein the digital transmission system is a digital television system, comprising broadcasting the software using the same transmission protocol as is used for the normal television content broadcast.

13. A method of transmitting software to one or more remote receivers, comprising:
converting the software program or programs to a format suitable for transmission to the remote receivers; and
providing the converted software program or programs to a transport stream for transmission to the remote receiver or receivers.

14. The method of any one of the preceding claims, comprising the system infrastructure determining the anticipated space available for the software transmission and tailoring the software transmission accordingly.

15. The method of claim 14, wherein the determination of the anticipated space available for the software transmission is based on the size of the software, and the space expected to be available in the transport stream in a given time interval.

16. A method of operating a transmission system in which software is to be transmitted in a digital transmission stream, comprising
determining the overall transmission capacity available in the transmission stream;
determining the transmission capacity required for current, non-software transmissions of the system; and
arranging the software for transmission in the transmission stream on the basis of the determined transmission capacities.

17. The method of any one of the preceding claims, comprising transmitting the software together with the information or data that the transmission system would in its normal use be transmitting to the remote terminals.

18. The method of claim 17, wherein the transmission system is a digital television system, comprising broadcasting the software alongside and/or within the linear television content being broadcast.

19. The method of claim 18, further comprising also broadcasting Internet content and/or other digital content together with the software and linear television content.

20. The method of claim 20, wherein the IP content is limited to a re-purposed front page to provide a visual bridge to an actual instructed dial-up to a URL or USL broadcast directly to the remote terminal.

21. The method of any one of claims 17 to 20, wherein the transmitted software is dependent upon the content of the other data being transmitted.

22. The method of claim 21, wherein the system is a television system, and is arranged such that changing TV channels means that the set top box receives new software specific to the new TV channel.

23. A method of operating a digital transmission system comprising one or more remote terminals and a system infrastructure that makes transmissions to the remote terminals, the method comprising:
the system infrastructure transmitting to the remote terminals computer software for use by the remote terminals.

24. A method of operating a digital television system comprising one or more set top boxes and a system infrastructure that makes transmissions to the set top boxes, the method comprising:
the system infrastructure transmitting to the set boxes computer software for use by the set top boxes.

25. The method of any one of the preceding claims, wherein the software to be transmitted is provided by a suitably located server.

26. The method of claim 25, wherein the system is a digital television system, and the server is located at the terrestrial, cable or satellite service provider's or broadcaster's head end of the system.

27. The method of claim 25 or 26, wherein the transmission server carries out the function of injecting the software resident on the server into the transmission stream.

28. The method of claim 25, 26 or 27, wherein the software transmission server coordinates and synchronises the different streams of digital content to be transmitted.

29. The method of any one of the preceding claims, wherein the digital transmission system is a digital television system, and the remote terminals are set top boxes of the system.

30. A method of operating a remote terminal of a digital transmission system, comprising:
the remote terminal receiving software transmitted by the system infrastructure and storing it in its resident memory, whereby the remote terminal may use the transmitted software.

31. A method of operating a set top box of a digital television system, comprising:
the set top box receiving software transmitted by the television system infrastructure and storing it in its resident memory, whereby the set top box may use the transmitted software.

32. The method of any one of the preceding claims, comprising the remote terminals identifying a software transmission that they wish to use, and then reading and reassembling the transmitted software, compiling it if necessary, and storing it in their local, resident memory, such that it is then available for use by the remote terminal.

33. The method of claim 32, wherein the BIOS (Basic Input Output System) of the remote terminal is arranged and/or modified to provide and carry out the functions of reading, compiling and loading the software.

34. The method of any one of the preceding claims, wherein the or each remote terminal is arranged, where two or more separate pieces of software are being transmitted, to automatically switch between the different pieces of software and replace one with the other in its local resident memory as the remote terminals software needs change.

35. The method of any one of the preceding claims, wherein the remote terminals automatically erase whatever transmitted software is stored in their resident memory when they seek a new transmission.

36. The method of any one of the preceding claims, wherein the remote terminals are configured to look for and access the transmitted software when the terminal is first powered on and/or in response to particular user inputs.

37. The method of any one of the preceding claims, wherein the remote terminals are arranged to at least seek software in the signal transmissions that they are receiving when they cannot find software code that they need in their local resident memory.

38. A method of operating a receiver of a digital transmission system, comprising:
the receiver determining whether a piece of software desired for operation by the receiver is stored by the receiver; and
the receiver, when it is determined that the piece of software is not stored by the receiver, seeking that software from a signal transmitted to the receiver by the digital transmission system.

39. The method of any one of the preceding claims, further comprising providing a return path for communication from the remote terminals to the transmission system infrastructure.

40. The method of any one of the preceding claims, wherein the digital transmission system is a digital television system, comprising transmitting interactivity enabling software that allows different streams of digital information to be shown simultaneously on a television screen.

41. A digital transmission system, comprising:
one or more remote terminals, each having a resident memory; and
a system infrastructure for making transmissions to the remote terminals of the system; wherein:
the system infrastructure comprises means for transmitting to the remote terminals computer software for use by the remote terminals; and
the or each remote terminal includes means for receiving the software and storing it in their resident memory, whereby the remote terminals may use the transmitted software.

42. The system of claim 41, wherein the digital transmission system is a digital television system.

43. A digital television system, comprising:
one or more remote digital television receivers each having a resident memory; and
means for broadcasting, as part of the television broadcast, software that can be used by the remote receiver or receivers; and wherein
the remote receiver or receivers include means for receiving the broadcast software and storing it in their resident memory, whereby the remote receivers can access the software and use it as necessary for their operation.

44. The system of any one of claims 41 to 43, wherein the system infrastructure comprises means for automatically transmitting the or each piece of software or sequence of software repeatedly in use.

45. The system of any one of claims 41 to 44, wherein the system infrastructure comprises means for transmitting the software in a continuously repeating loop, such that a given piece of software will become repeatedly available to the remote terminals over time.

46. An apparatus for transmitting software to one or more remote receivers, comprising:
means for storing one or more software programs for broadcast to the remote receivers;
means for converting the stored software program or programs to a format suitable for transmission to the remote receivers; and
means for providing the converted software program or programs to a transport stream for transmission to the remote receiver or receivers.

47. The system or apparatus of any one of claims 41 to 46, wherein the apparatus or system infrastructure comprises means for determining the anticipated space available for the software transmission and for tailoring the software transmission accordingly.

48. A transmission system in which software is to be transmitted in a digital transmission stream, comprising
means for determining the overall transmission capacity available in the transmission stream;
means for determining the transmission capacity required for current, non-software transmissions of the system; and
means for arranging the software for transmission in the transmission stream on the basis of the determined transmission capacities.

49. The system or apparatus of any one of claims 41 to 48, wherein the apparatus or system infrastructure comprises means for transmitting the software together with the information or data that the apparatus or transmission system would in its normal use be transmitting to the remote terminals.

50. The system or apparatus of claim 49, wherein the transmission system is a digital television system, and the apparatus or system infrastructure comprises means for broadcasting the software alongside and/or within the linear television content being broadcast.

51. Apparatus for making transmissions to remote terminals of a digital transmission system, comprising:
means for transmitting to the remote terminals computer software for use by the remote terminals.

52. Apparatus for making transmissions to set top boxes of a digital television system, comprising:
means for transmitting to the set top boxes computer software for use by the set top boxes.

53. The system or apparatus of any one of claims 41 to 52, wherein the software to be transmitted is provided by a suitably located server.

54. The system or apparatus of claim 53, wherein the system is a digital television system, and the server is located at the terrestrial, cable or satellite service provider's or broadcaster's head end of the system.

55. The system or apparatus of claim 53 or 54, wherein the transmission server comprises means for injecting the software resident on the server into the transmission stream.

56. The system or apparatus of claim 53, 54 or 55, wherein the software transmission server comprises means for coordinating and synchronising the different streams of digital content to be transmitted.

57. The system or apparatus of any one of claims 41 to 56, wherein the digital transmission system is a digital television system, and the remote terminals are set top boxes of the system.

58. A remote terminal of a digital transmission system, comprising:
a resident memory; and
means for receiving software transmitted by the system infrastructure and storing it in the resident memory, whereby the remote terminal may use the transmitted software.

59. A set top box of a digital television system, comprising:
a resident memory; and
means for receiving software transmitted by the television system infrastructure and storing it in the resident memory, whereby the set top box may use the transmitted software.

60. The system or apparatus of any one of claims 41 to 59, wherein the remote terminals comprise means for identifying a software transmission that they wish to use, means for reading and reassembling the transmitted software, means for compiling it if necessary, and means for storing the transmitted software in their local, resident memory, such that it is then available for use by the remote terminal.

61. The system or apparatus of claim 60, wherein the BIOS (Basic Input Output System) of the remote terminal is arranged and/or modified to provide and carry out the functions of reading, compiling and loading the software.

62. The system or apparatus of any one of claims 41 to 61, wherein the or each remote terminal comprises means for, where two or more separate pieces of software are being transmitted, automatically switching between the different pieces of software and replacing one with the other in its local resident memory as the remote terminal's software needs change.

63. The system or apparatus of any one of claims 41 to 62, wherein the remote terminals comprise means for automatically erasing whatever transmitted software is stored in their resident memory when they seek a new transmission.

64. The system or apparatus of any one of claims 41 to 63, wherein the remote terminals are configured to look for and access the transmitted software when the terminal is first powered on and/or in response to particular user inputs.

65. The system or apparatus of any one of claims 41 to 64, wherein the remote terminals are arranged to at least seek software in the signal transmissions that they are receiving when they cannot find software code that they need in their local resident memory.

66. A receiver of a digital transmission system, comprising:
means for determining whether a piece of software desired for operation by the receiver is stored by the receiver; and
means for, when it is determined that the piece of software is not stored by the receiver, seeking that software from a signal transmitted to the receiver by the digital transmission system.

67. The system or apparatus of any one of claims 41 to 66, further comprising a return path for communication from the remote terminals to the transmission system infrastructure.

68. A computer program element comprising computer software code portions for performing the method of any one of claims 1 to 40 when the program element is run on data processing means.

69. A method of operating a digital transmission system substantially as hereinbefore described with reference to any one of the accompanying drawings.

70. A digital transmission system substantially as hereinbefore described with reference to any one of the accompanying drawings.

71. A remote terminal of a digital transmission system substantially as hereinbefore described with reference to any one of the accompanying drawings.
